(19) United States
(12) Patent Application Publication
(10) Pub. No.: US 2006/0231218 A1
(43) Pub. Date: Oct. 19, 2006

(54) Supporting gear structure for retractable folding doors

(75) Inventor: Wen Ying Liang, Lugang Town (TW)

Correspondence Address: TROXELL LAW OFFICE PLLC, SUITE 1404, 5205 LEESBURG PIKE, FALLS CHURCH, VA, 22041, US

(73) Assignee: Ching Feng Home Fashions Co., Ltd.

(21) Appl. No.: 11/171,523

(22) Filed: Jul. 1, 2005

(30) Foreign Application Priority Data
Apr. 15, 2005 (TW) 094205904

(51) Int. Cl. E05D 15/26

(52) U.S. Cl. 160/206

(57) ABSTRACT

A supporting gear structure for retractable folding doors comprises a folding door made up of multiple pivotally connected and retractably operated door panels wherein both lateral outer door panels are respectively disposed a fixed side and a movable side each having a sealing cap fixed thereto, and the sealing cap has a connecting rod with a positioning stop seat to be coupled with a support member having a coupling groove, a base mount, and a guide rod with a protrusive flange defined by a tapered guide surface to be accommodated into a guide opening of a top rail and a support surface to be precisely hanged on stop hooks of the top rail thereby. Therefore, the support members with a lower support plate can stably bear the weight and permit smooth sliding movement of the folding door at the top rail thereon to achieve the best application state thereof.

### BACKGROUND OF THE INVENTION

The present invention is related to a supporting gear structure for retractable folding doors, comprising a folding door made up of multiple pivotally connected and retractably operated door panels wherein both lateral outer door panels are respectively disposed a fixed side and a movable side each having a sealing cap fixed thereto, and the sealing cap has a connecting rod to be coupled with a support member having a support surface defining thereon that can be precisely hanged on stop hooks of a top rail. Therefore, the support members with a lower support plate can stably bear the weight and give support to the folding door, permitting smooth and even sliding movement of the folding door at the top rail thereon to achieve the best application state thereby.

Please refer to FIG. 1. A conventional retractable folding door 10 for partition as found on the market includes a fixed side 11 whose top and bottom edges are respectively locked to a top rail 12 and a lower support plate 13, and a movable side 14 equipped with a guide rod 15 protruding at the top edge thereon to be drawn or pushed by force to slide along the top rail 12 for expanding and stacking the folding door 10 thereby.

There are some drawbacks to such conventional folding door 10. Most of all, the fixed side 11 of the folding door 10 is positioned and supported by the top rail 12 and the lower support plate 13, and only the guide rod 15 of the movable side 14 is pivotally accommodated to slide on the top rail 12 thereof. In case the folding door 10 is drawn or pushed too fast, the guide rod 15 of the movable side 14 without any other support to bear the weight of the folding door 10 tends to get derailed and slanted downwards from the top rail 12 due to the weight of the folding door 10 thereof, which can cause inconvenience in the operation thereof and destroy the beauty of the folding door 10 thereby.

### SUMMARY OF THE PRESENT INVENTION

It is, therefore, the primary purpose of the present invention to provide a supporting gear structure for retractable folding doors, comprising a folding door made up of multiple pivotally connected and retractably operated door panels wherein both lateral outer door panels are respectively disposed a fixed side and a movable side each having a support member with a protrusive flange defined by a support surface at the bottom edge to be precisely hanged onto a set of stop hooks extending at both sides of a top rail thereby so that the support members with a lower support plate can stably bear the weight and precisely give support to the folding sliding door, permitting smooth and even sliding movement of the folding door at the top rail thereon to achieve the best application state thereof.

It is, therefore, the second purpose of the present invention to provide a supporting gear structure for retractable folding doors wherein the protrusive flange of the support member is provided with a conic tapered guide surface defining the top edge thereon to be guided along the stop hooks of the top rail and accommodated into a guide opening of the top rail thereby, providing a smooth guidance in the assembly to avoid jamming problem for an easier assembly thereof.

### BRIEF DESCRIPTION OF THE DRAWINGS

FIG. 1 is a diagram showing a conventional retractable folding door get slanted and deformed in the sliding operation thereof.

FIG. 2 is an exploded perspective view of the present invention.

FIG. 3 is an assembled view of the present invention evenly drawn in full expansion.

FIG. 4 is an assembled cross sectional view of a sealing cap of the present invention mounted to a door panel thereof.

FIG. 5 is an assembled cross sectional view of a support member of the present invention coupled with a connecting rod of the sealing cap thereof.

FIG. 6 is an assembled cross sectional view of the support member disposed at a movable side of the present invention and accommodated into a top rail thereof.

FIG. 7 is an assembled cross sectional view of the support member disposed at a fixed side of the present invention and mounted to the top rail thereof.

FIG. 8 is diagram showing the support member of the fixed side thereof locked to both the top rail and a fixing support element in assembly.

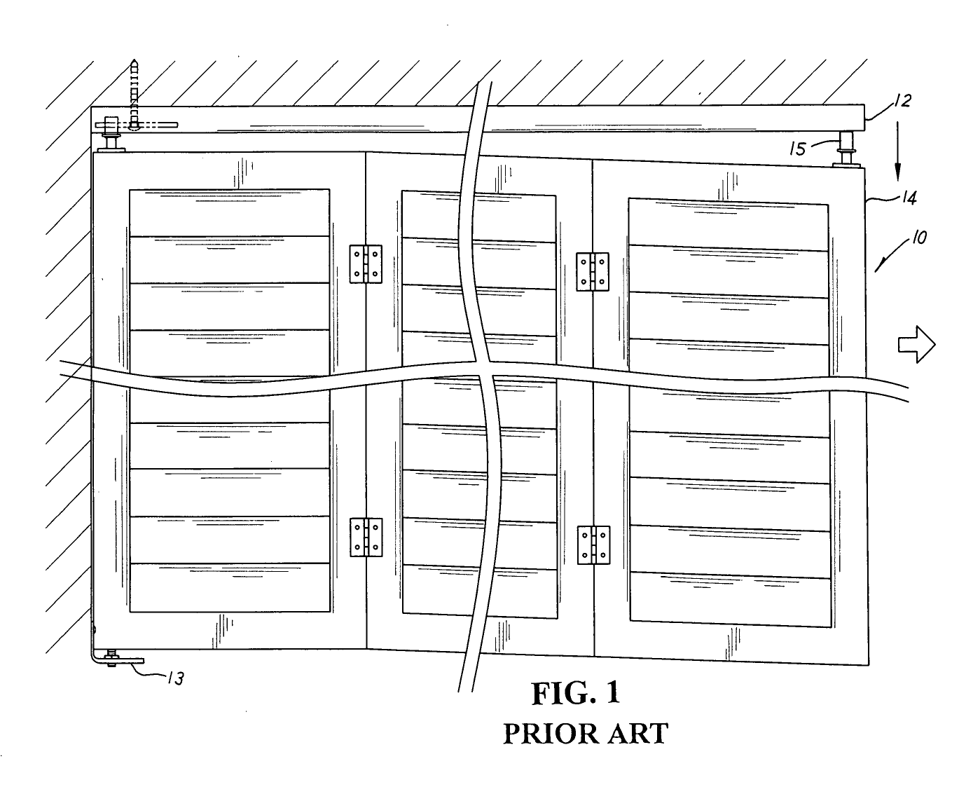

### DETAILED DESCRIPTION OF THE PREFERRED EMBODIMENTS

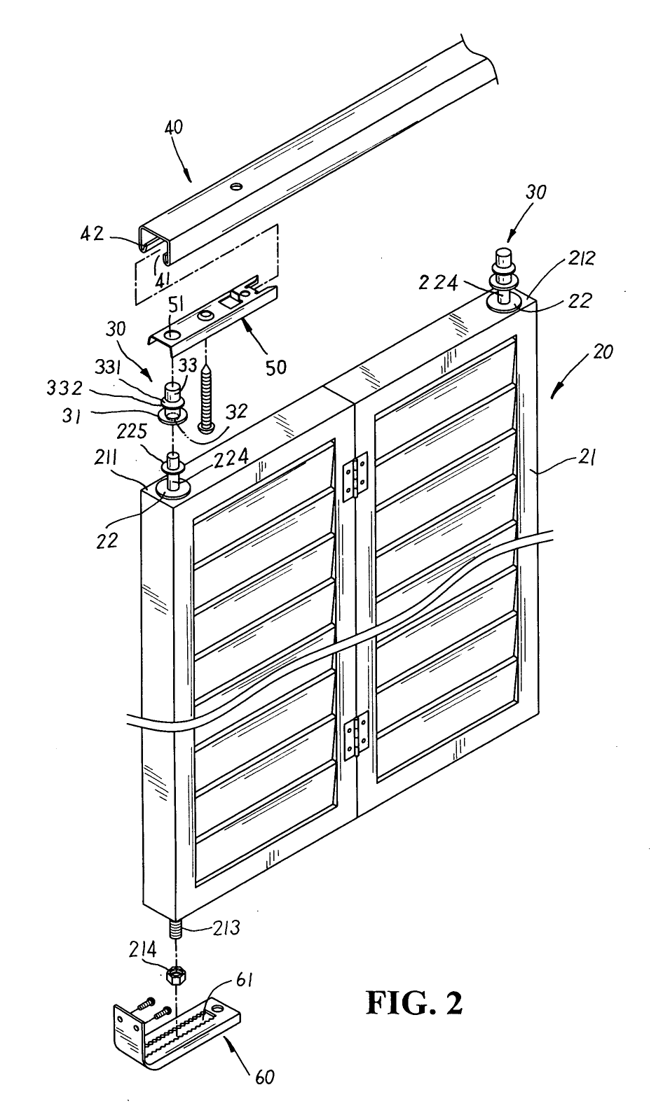

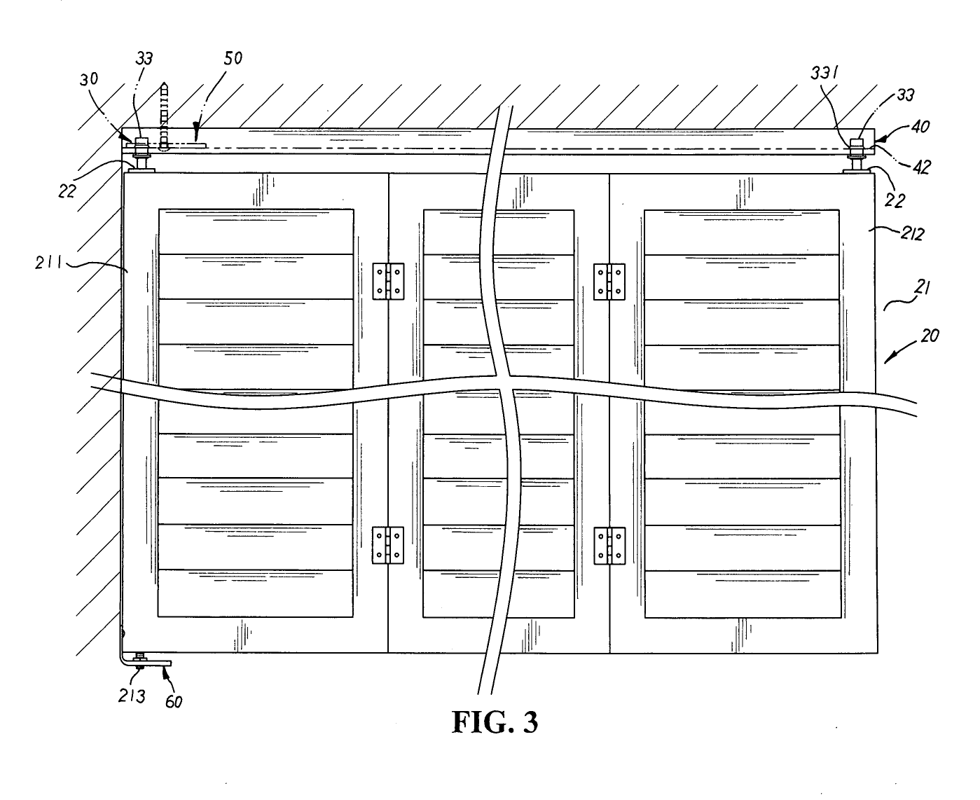

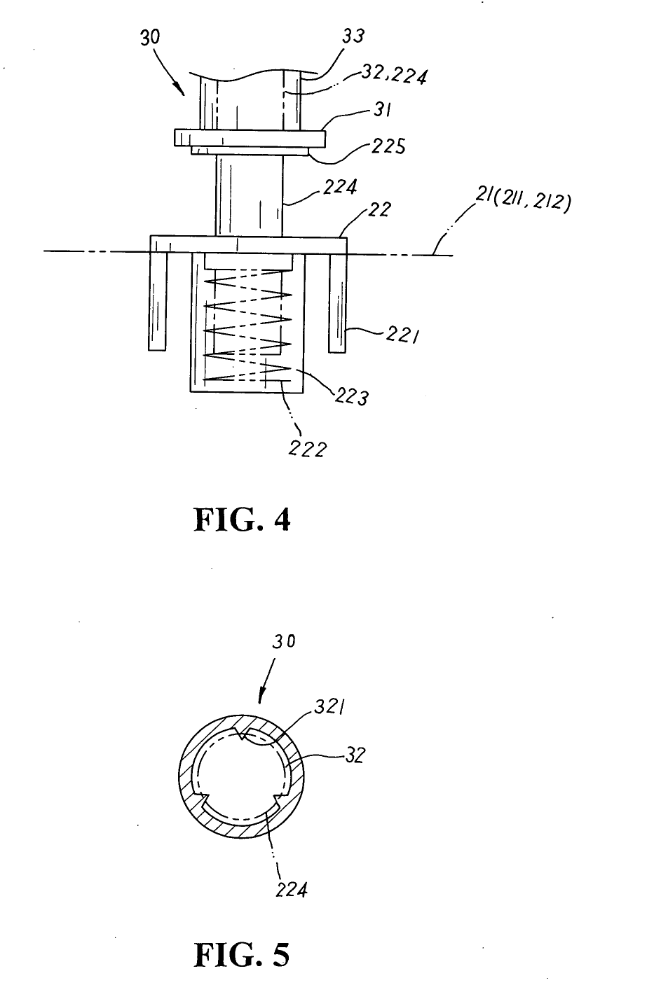

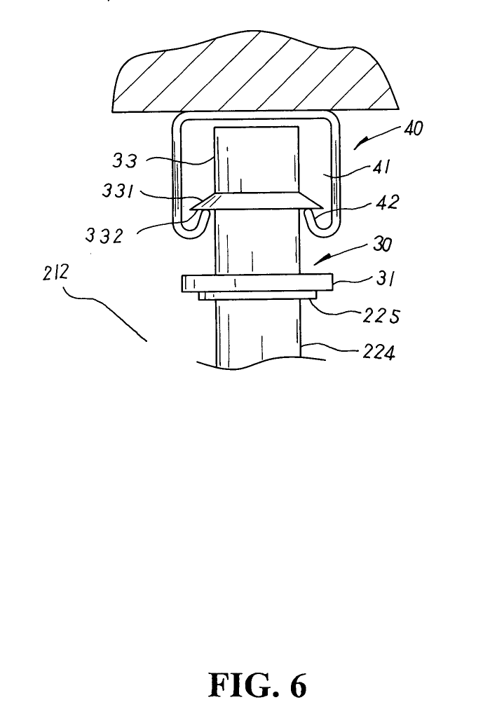

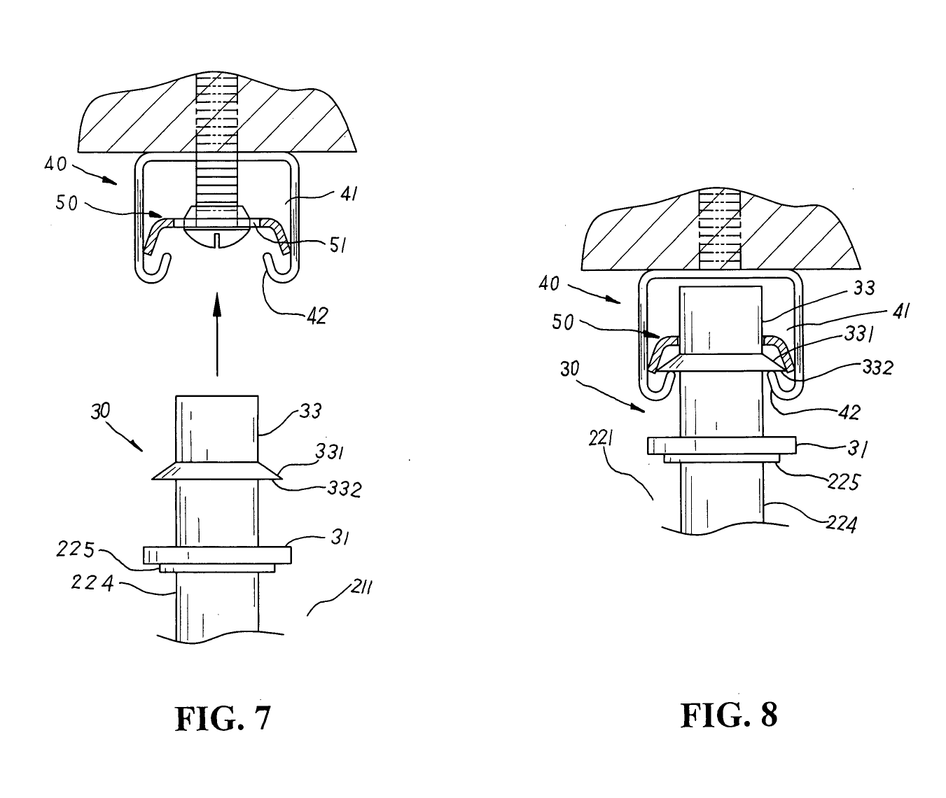

Please refer to FIG. 2 showing an exploded perspective view of the present invention (accompanied by FIG. 3 showing the present invention in full expansion). The present invention is related to a supporting gear structure for retractable folding doors, comprising a folding door 20 made up of a plurality of pivotally connected door panels 21 that can be mutually stacked or expanded in operation. At the corresponding opposite upper edges of both lateral outer door panels 21 are respectively disposed a fixed side 211 and a movable side 212 each having a sealing cap 22 mounted thereto. The sealing cap 22 (referring to FIG. 4) is equipped with a plurality of resilient legs 221 extending at the bottom section thereon to be securely fixed into the interior of the door panel 21 thereby, and in the middle of the bottom section thereof is downwardly disposed a hollow tube 223 having a spring element 222 accommodated therein to be coupled with a connecting rod 224 that is flexibly supported by the spring element 222 to protrude outwards at the upper edge of the sealing cap 22 thereof. The connecting rod 224 thereof has a positioning stop seat 225 annularly extending at an appropriate position thereon for the engagement of a support member 30 therewith. The support member 30 has a base mount 31 of a larger diameter disposed at the bottom thereon, and a coupling groove 32 defining upwards in the middle thereof for the registration of the connecting rod 224 therewith with the base mount 31 precisely abutted against the positioning stop seat 225 thereby. The coupling groove 32 thereof has a plurality of toothed ribs 321 annularly extending at the inner wall thereon to tightly mesh with the connecting rod 224 (referring to FIG. 5) so that the support member 30 can be precisely bonded with the connecting rod 224 thereby. The support member 30 also includes a guide rod 33 extending upwards on top of the base mount 31 thereof to reciprocally match with a guide opening 41 of a top rail 40, and at the middle section of the guide rod 33 is disposed a conic protrusive flange 331 defined by a tapered guide surface at the upper edge thereon and a retaining support surface 332 disposed at the bottom edge thereon. The tapered guide surface of the guide rod 33 can be led along a set of stop hooks 42 extending at both side of the top rail 40 and forced into the guide opening 41 via a flexible space produced at the pressed stop hooks 42 thereof, permitting the support surface 332 thereof to precisely hang on the stop hooks 42 so as to give support to the weight of the folding door 20 as shown in FIG. 6. A fixing support element 50 shaped in an inverted U-like configuration as shown in FIGS. 7, 8 is provided to lock to the interior at one side of the guide opening 41 of the top rail 40 precisely corresponding to the fixed side 211 of the folding door 20 thereof. The fixing support element 50 is equipped with a fixing hole 51 disposed at an appropriate position thereon for the engagement therewith of the guide rod 33 of the support member 30 mounted at the fixed side 211 thereon so as to limit the movement of the guide rod 33 thereby. At the bottom edge of the fixed side 211 thereof is disposed a screwed bolt-like positioning post 213 axially aligned with the guide rod 33 of the support member 30 and extending downwards to pass through a serrated adjusting slot 61 of a lower support plate 60 so that the positioning post 213 can be adjustably moved and engaged with the serrated adjusting slot 61 in alignment with the position of the guide rod 33 reciprocally locked to the fixing hole 51 of the support member 50 thereof to adjust and strengthen the vertical expansion of the folding door 20 thereby. A nut-like locking part 214 is screwed at an appropriate position of the positioning post 213 thereon to abut tight against the lower support plate 60 for secure engagement and support thereby.

Please refer to FIG. 3. When the folding door 20 is drawn in fully expanded state (or pushed in stacked-up state), the support member 30 and the positioning post 213 mounted at the top and bottom edges of the fixed side 211 thereof are respectively limited in movement via the fixing support element 50 and the lower support plate 50 engaged therewith so that the guide rod 33 of the support member 30 mounted at the movable side 212 thereof can be smoothly slid along the guide opening 41 of the top rail 40 by a drawing (or pushing) force applied thereto so as to sequentially expand (or stack) each door panel 21 thereby. Meanwhile, the support surfaces 332 of the support members 30 respectively mounted at the fixed and the movable sides 211, 212 thereof are securely hanged on the stop hooks 42 extending at both sides of the top rail 40, permitting the support members 30 synchronically operated with the lower support plate 60 thereof to stably bear the weight of the folding door 20 and give precise support thereto so that the folding door 20 can be smoothly and evenly slid at the top rail 40 thereon to achieve the best application state thereby.

What is claimed is:

1. A supporting gear structure for retractable folding doors, comprising a folding door made up of a plurality of pivotally connected door panels that can be mutually stacked or expanded in operation wherein at the corresponding opposite upper edges of both lateral outer door panels are respectively disposed a fixed side and a movable side each having a sealing cap mounted thereto, and the sealing cap has a connecting rod with a positioning stop seat extending upwards to be coupled with a support member having a coupling groove and a base mount provided therewith; the support member also includes a guide rod extending upwards on top of the base mount to be pivotally guided and accommodated into a guide opening of a top rail thereby, and the guide rod of the support member mounted at the fixed side thereon is engaged with a fixing hole of a fixing support element; at the bottom edge of the fixed side thereof is disposed a positioning post led and fixed to an adjusting slot of a lower support plate thereby; the present invention be characterized by that;
the guide rod of the support member has a protrusive flange extending at an appropriate position thereon to be accommodated into the top rail and supported by a set of stop hooks disposed at both sides of the top rail so as to stably hang the folding door at the top rail thereon.

2. The supporting gear structure for retractable folding doors as claimed in claim 1 wherein the protrusive flange of the guide rod thereof is equipped with a tapered guide surface to form a conic configuration at the upper edge thereon.

3. the supporting gear structure for retractable folding doors as claimed in claim 1 wherein the protrusive flange of the guide rod thereof has a retaining support surface defining the lower edge thereon.

4. The supporting gear structure for retractable folding doors as claimed in claim 1 wherein to accommodate the protrusive flange of the guide rod into the top rail thereof, the stop hooks of the top rail is pressed to produce a flexible space, permitting the protrusive flange thereof to enter the guide opening of the top rail thereby.
